(19) United States
(12) Patent Application Publication
(10) Pub. No.: US 2002/0178020 A1
(43) Pub. Date: Nov. 28, 2002

(54) Data communication system and method

(76) Inventors: Andreas Simon, Munich (DE); Axel Jerabek, Munich (DE)

Correspondence Address: J. PETER FASSE, Fish & Richardson P.C., 225 Franklin Street, Boston, MA, 02110-2804, US

(21) Appl. No.: 09/915,646

(22) Filed: Jul. 26, 2001

(30) Foreign Application Priority Data
May 23, 2001 (DE) 10125333.8

(51) Int. Cl. G06F 17/60

(52) U.S. Cl. 705/1

(57) ABSTRACT

A data communication system includes output devices, input devices allocated to users, and at least one host computer, wherein identical information is output at the output devices, the host computer transmits to the output devices further information allocated to the identical information, and data relating to the further information and input into the input devices are transmitted to the host computer. In this system, the host computer selects, in response to the data received from the input devices, one of the users or a subset of users, and transmits a selected message to the one user or subset of users.

### TECHNICAL FIELD

This invention relates to a data communication system.

### CLAIM OF PRIORITY

This application claims priority under 35 USC §119(e) to German Patent Application Serial No. 10125333.8, filed on May 23, 2001, the entire contents of which are hereby incorporated by reference.

### BACKGROUND

Data communication systems include a plurality of output devices, e.g. television sets. The television sets receive sound and/or image data that are, for instance, transmitted by a master station of a private or public television corporation. The screen of the respective television set displays the images corresponding to the image data. In addition, the loudspeaker(s) of the respective television sets emit(s) the sound signals corresponding to the sound data.

A television program broadcasted by the respective master station usually includes commercial programs in addition to the actual entertainment and information programs. Each commercial program in general includes several, for instance five, six or seven, individual advertising spots, each of them promoting a particular product or a particular service.

In the case of conventional programs, a viewer in general pays only little attention to the individual advertising spots. Frequently, there is so little interest that the viewer changes the channel while a commercial program is broadcasted, leaves the room, starts a conversation, etc.

### SUMMARY

In one aspect, the invention features a data communication system including a plurality of output devices, a plurality of input devices allocated to a plurality of users, and at least one host computer, wherein identical information is output at the output devices, and the host computer transmits to the output devices further information allocated to the identical information, data relating to the further information and input into the plurality of input devices are transmitted to the host computer, the host computer designed to select, in response to the data received from the plurality of input devices, one of the users and transmit a message of selection to the one user.

One or more of the following features may also be included. The identical information is advertising information allocated to a particular product or service. The further information allocated to the identical information are questions directed to the one user of the respective input device. The further information allocated to the identical information are questions directed to the one user of the respective input device. The host computer selects the one user whose answers to the questions correspond to a set of reference answers stored in the host computer. The set of reference answers is determined from answers given by the plurality of users. The set of reference answers is determined on the basis of a frequency of individual answers given by the plurality of users. Answers contained in the set of reference answers correspond to answers selected by a particular one of the plurality of users. The system also includes at least 1,000 input devices, and at least 1,000 output devices. The identical information is transmitted from a master station. The plurality of input devices is mobile phones. The plurality of output devices is the mobile phones. The plurality of output devices is television sets.

In another aspect of the invention, a data communication method includes outputting identical information to a plurality of output devices, transmitting from a host computer further information associated with the identical information to the plurality of output devices, and providing a plurality of input devices allocated to a plurality of different users such that that data relating to the further information and input into the respective input devices are transmitted to the host computer, and the host computer selects, in reaction to the data received from the input devices, one of the plurality of users and transmits a message of selection to the one selected user.

Other features, objects, and advantages of the invention will be apparent from the description and drawings, and from the claims.

### BRIEF DESCRIPTION OF DRAWINGS

FIG. 1 is schematic diagram of a data communication system according to a first embodiment of the present invention.

FIG. 2 is schematic representation of one of the input/output devices of FIG. 1.

FIG. 3 is a cross-reference table stored in the host computer of FIG. 1.

FIG. 4a illustrates a further table (for a first user) stored in the host computer of FIG. 1.

FIG. 4b is an evaluation table stored in the host computer of FIG. 1.

FIG. 4c is a further table (for a second user) stored in the host computer of FIG. 1.

FIG. 4d is a further table (for a further user) stored in the host computer of FIG. 1.

FIG. 4e is a further evaluation table stored in the host computer of FIG. 1.

FIG. 5 is a schematic diagram of a data communication system according to a second embodiment of the invention.

FIG. 6a is a representation of one of the mobile phones of FIG. 5.

FIG. 6b is a schematic detailed representation of one of the computers of FIG. 5.

FIG. 7 is a cross-reference table stored in the host computer of FIG. 5.

FIG. 8a illustrates a further table stored in the host computer of FIG. 5.

FIG. 8b is an evaluation table stored in the host computer of FIG. 5.

FIG. 8c is a further table (for a second user) stored in the host computer of FIG. 5.

FIG. 8d illustrates a further table (for a further user) stored in the host computer of FIG. 5.

FIG. 8e illustrates a further evaluation table stored in the host computer of FIG. 5.

### DETAILED DESCRIPTION

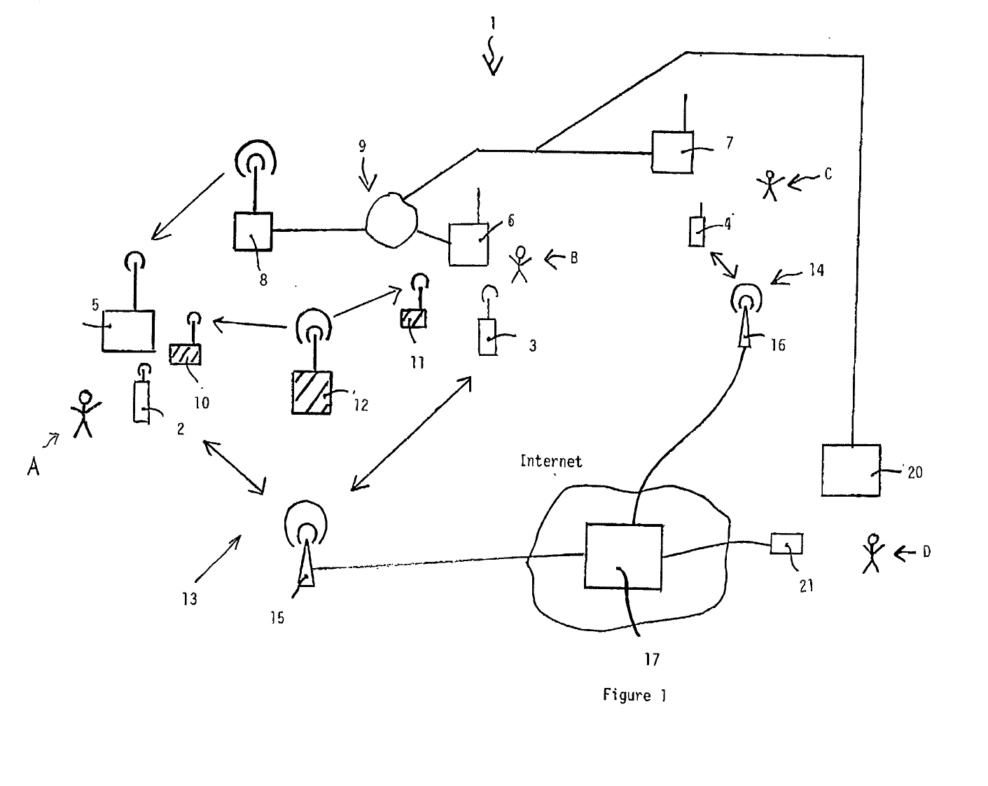

Referring to FIG. 1, a data communication system 1 includes a plurality of output/input devices, here: a first mobile phone 2, a second mobile phone 3, a third mobile phone 4, and a plurality of further (e.g., more than 1,000, in particular more than 10,000 or more than 100,000) mobile phones not shown, as well as a first television set 5, a second television set 6, a third television set 7, and a plurality of further television sets not shown.

The television sets 5, 6, 7 receive sound/image data that are transmitted in accordance with a certain television transmission standard (e.g., PAL, NTSC, SECAM, or D2-MAC) by a master station 8 of a private or public television corporation. The data may, for example, be transmitted via a cable network 9, or, for instance, wireless—alternatively by additional interconnection of satellites—to the respective television sets 5, 6, 7. The images corresponding to the image data are displayed on the screens of the respective television sets 5, 6 and 7. In addition, the loudspeaker(s) of the respective television sets emit(s) the sound signals corresponding to the sound data.

Alternatively or additionally to the television sets 5, 6, 7, the data communication system 1 may include a plurality of radio receivers 10, 11 receiving audio data transmitted by a master station 12 of a private or public radio corporation and emitting acoustic signals corresponding to the audio data.

The television or radio program broadcasted by the master stations 8, 12 of the respective television or radio corporations usually includes, in addition to the actual entertainment and information programs, commercial programs. Each commercial program in general includes several, for instance five, six or seven, individual advertising spots, each of them promoting a particular product or a particular service.

The images of the advertising spots represented on the screens of the television sets 5, 6, 7 and the pertinent texts of the advertising spots emitted by the loudspeakers of the television sets may be viewed or listened to, respectively, by the users A, B, C of the data communication system 1. Alternatively or additionally, the users A, B C may listen to the text of advertising spots broadcasted by the above-mentioned radio receivers 10, 11.

One of the abovementioned input/output devices, specifically, one of the above-mentioned mobile phones 2, 3, 4, is allocated to each of the users A, B, C. The mobile phones 2, 3, 4 have WAP or Internet capability. Alternatively, conventional GSM mobile phones may be used, with the transmission of data being performed via SMS instead of via the Internet as explained below.

The mobile phones 2, 3, 4 are linked with corresponding mobile radiotelephone networks 13, 14 via mobile radiotelephone network base stations 15, 16 and perform bi-directional data communication with the respective base stations of the mobile radio-telephone networks 13, 14, by making use of the WAP, GPRS or UMTS protocol, for example. From the respective base stations 13, 14, the data are, by interconnection of one or several host computers, e.g. telephone connection relay computers, transmitted to the Internet and, from there, to an Internet host computer 17. The Internet host computer 17 transmits the WAP or Internet sites requested by a particular mobile phone 2, 3, 4 (or the image data (or image-/sound data) requested by it) via the Internet, the abovementioned host computers and the mobile radiotelephone network base stations 15, 16 to the respective requesting mobile phone 2, 3, 4.

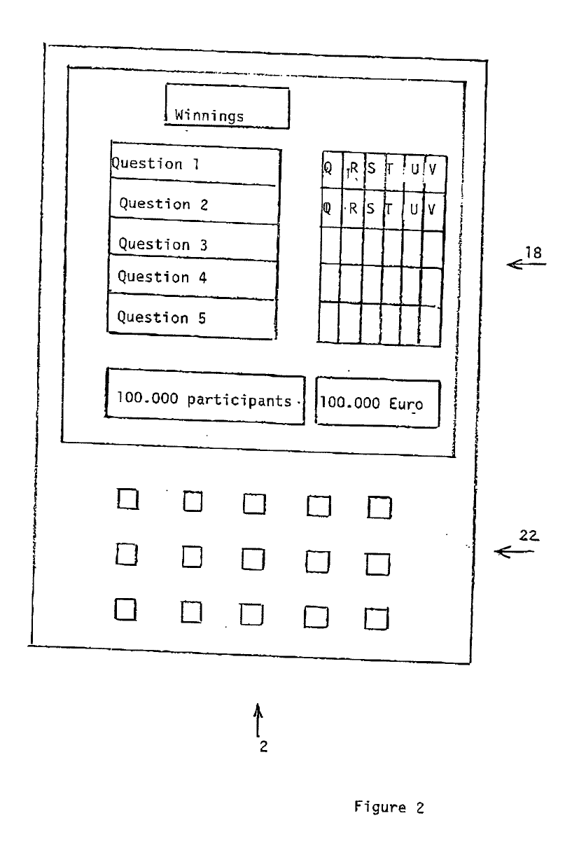

Referring to FIG. 2, each mobile phone 2 includes a display 18 and an input means such as a keyboard 22.

The display 18 of the respective mobile phone 2 displays images corresponding to the image data emitted by the host computer 17. Additionally, a loudspeaker may be provided at the mobile phone 2 which emits sound signals corresponding to the sound data emitted by the host computer 17. The images displayed on the display 18 (and possibly the sound signals emitted by the loudspeaker) may be viewed (or listened to) by the respective user of the data communication system, e.g. user A.

The display 18 of the mobile phone 2 displays (or, if available, its loudspeaker emits), caused by the host computer 17, data that relate to the respective commercial program or the respective advertising spot broadcasted by the television set or radio receiver 5, 10, i.e., the sound/image data or the sound data, respectively, received by the television set or radio receiver from the master station 8, 12, in particular text and/or spoken messages. These may, for instance, be questions which the respective user A is asked with regard to the individual advertising spots, i.e., questions 1, 2, 3, 4, 5.

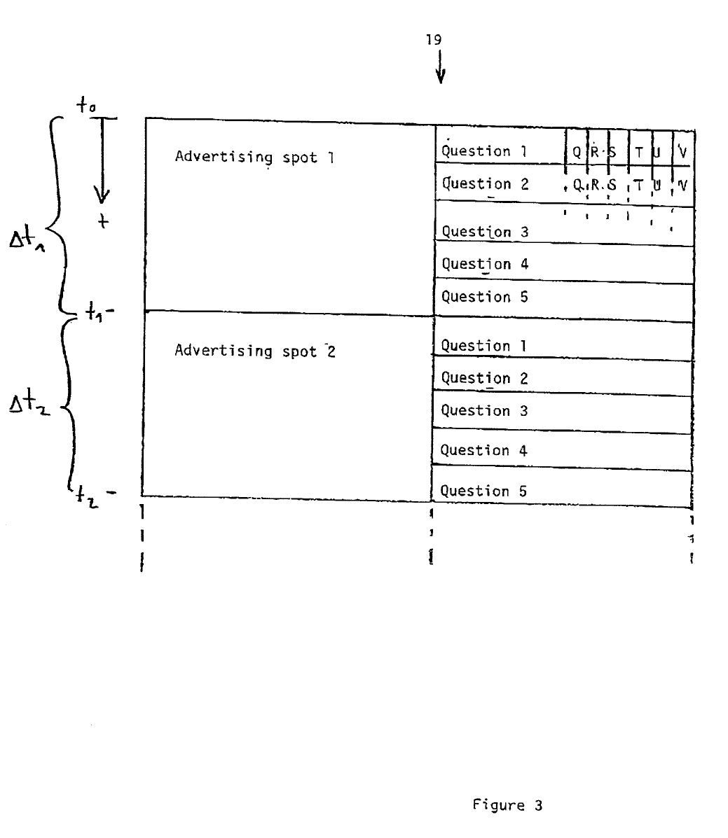

Referring to FIG. 3, a data cross-reference table 19 is stored in a database in a storage means (not shown) of the Internet host computer 17. In the cross-reference table 19, the image data or image/sound data, respectively, transmitted by the Internet host computer 17 to the respective mobile phone 2, e.g. the above-mentioned questions 1, 2, 3, 4, 5, are allocated to particular sound/image data or sound data, respectively, e.g. a particular advertising spot, broadcasted by the television or radio master station 8, 12. In another example, by means of a cross-reference table, the allocation of data may also be achieved by means of a correspondingly installed relational database stored in the storage means.

Referring again to FIG. 1, the data communication system 1 further includes a television set 20 (and/or possibly a further radio receiver) receiving, like the other television sets 5, 6, 7 (or the other radio receivers 10, 11, respectively) the data emitted by the master station 8, 12, e.g., via the cable network 9, in particular the above-mentioned commercial program with the advertising spots. The corresponding images of the advertising spots (or the texts of the advertising spots, respectively) are represented on a screen of the further television set 20 (or emitted by a loudspeaker of the radio receiver, respectively), and may be viewed (or listened to) by a person D who is responsible for the control of the data communication system 1.

By corresponding inputs into a keyboard 21 linked with the host computer 17, this person D sees to it that the host computer 17 transmits, at a time to at which the first advertising spot is broadcasted (or shortly before or afterwards) the questions allocated to the first advertising spot 1 to the mobile phones 2, 3, 4 in the way described above. In a corresponding way, the person D who is responsible for the control of the data communication system 1 sees to it that the corresponding questions allocated to the second advertising spot are transmitted at a time t₁, at which the second advertising spot is broadcasted (or shortly before or afterwards), and so forth.

Data transmission by the host computer 17 alternatively may also be effected automatically, e.g., by addressing a control software stored on a storage means of the host computer 17 and running on a host computer microprocessor.

If the time to at which the first advertising spot is broadcasted and/or the times t₁, t₂ at which the following advertising spots are broadcasted (or the duration Δt1, Δt2, etc. of the individual advertising spots, respectively) is/are known, they may be stored in the storage means of the host computer 17 (of FIG. 3). For instance, in accordance with FIG. 1, the times t₀, t₁, t₂ (or the durations Δt1, Δt2, respectively) may in advance be input via the keyboard 21 and be transmitted to the storage means of the host computer. Alternatively, the times t₀, t₁, t₂ (or the durations Δt1, Δt2, respectively) may also be transmitted from the respective television or radio corporation, e.g., from the master station 8, 12, to the host computer 17 via an Internet connection (not shown) and be stored in the storage means there.

The host computer 17 includes a timer (not shown). The time indicated by this timer is compared with the above-mentioned times t₀, t₁, t₂. The times t₁, t₂ may, for instance, also be determined by the host computer 17 adding the above-mentioned durations Δt1, Δt2 to the time t₀. If the time indicated by the timer concurs with one of the above-mentioned times t₀, t₁, t₂, the questions allocated to the advertising spots are automatically passed on to the mobile phones 2, 3, 4.

The questions relating to the advertising spots are, for instance, asked such that they have to be answered with “Yes” or “No.” Examples may include, “Do you like this advertising spot?” “Do you like this product?” “Are you interested in buying this product?”, or, for instance, with one out of several, e.g., four, five or six, predetermined possible answers (examples include: “How do you like this advertising spot?” “How do you like the leading actress?” “How do you like this product?”, the possible predetermined answers being Q, R, S, T, U, V “excellent”, “very good”, “good”, “average”, “bad”, “very bad”.

Referring again to FIG. 3, the predetermined answers Q, R, S, T, U, V are allocated to the corresponding questions and also stored in the storage means of the host computer 17 and are transferred, together with the questions, to the respective mobile phones 2, 3, 4, intermediately stored there and displayed on the respective display 18.

The user A of the mobile phone 2 may select one of the predetermined answers by performing a corresponding input with the keyboard 22, for instance by clicking (alternatively, the selection may be carried out in any other way, e.g., in the case of a touch screen display by touching corresponding spots of the display 18).

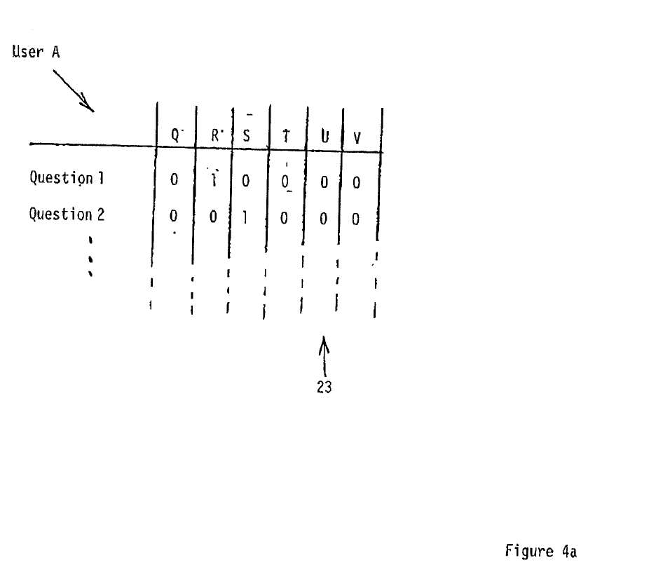

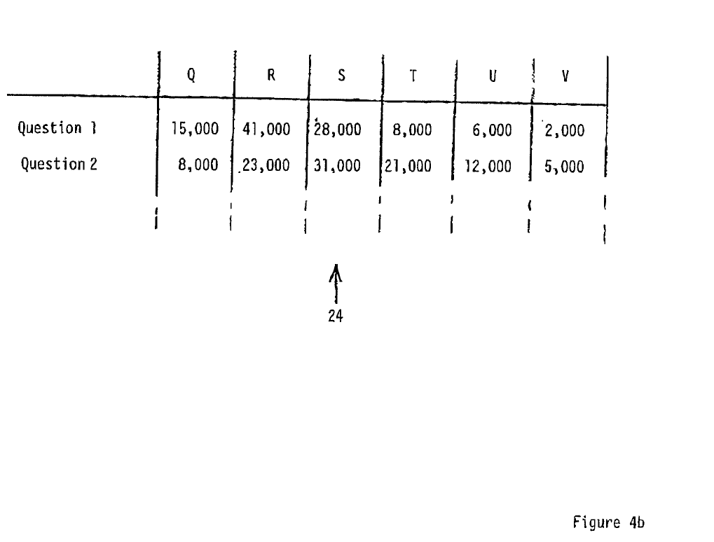

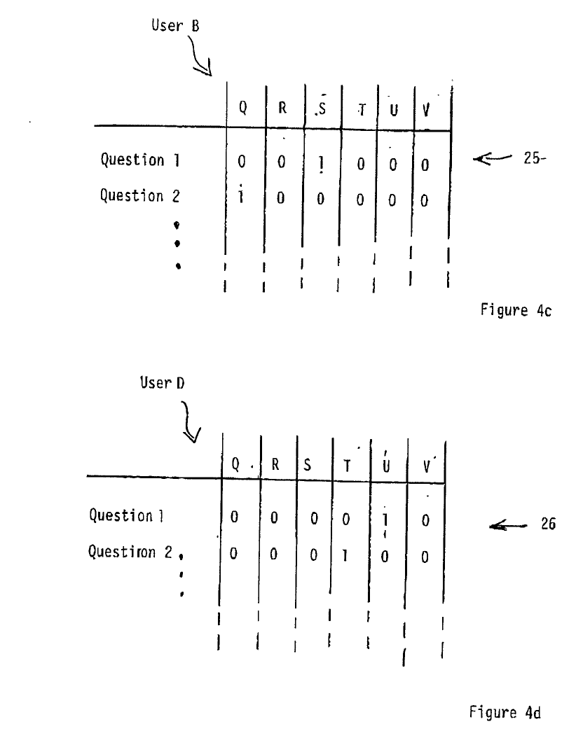

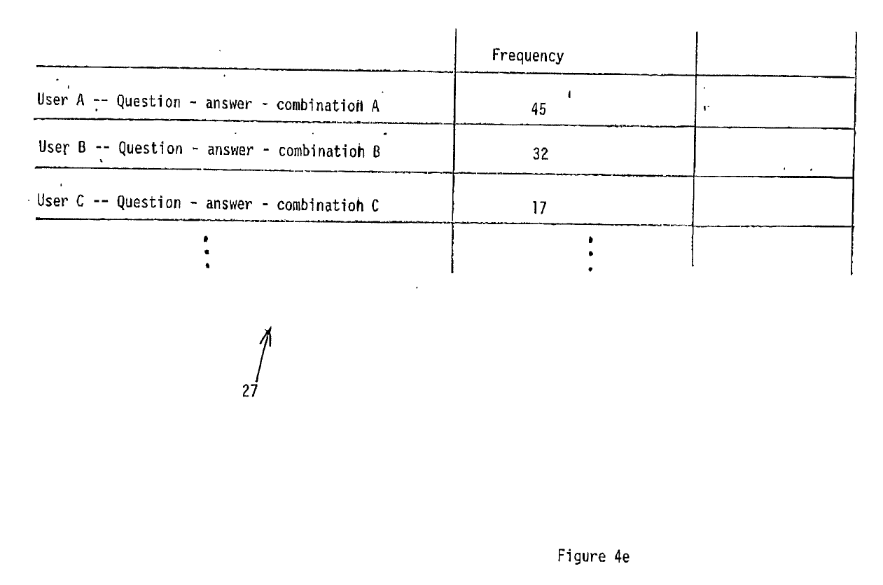

Referring again to FIG. 1, the answers (e.g., in the form of different bit sequences allocated to each answer) are transmitted from the respective mobile phone 2 via the respective mobile radiotelephone network base station 15 and the above-mentioned host computers to the Internet, and from there to the host computer 17 where, as shown in FIGS. 4a, 4b and 4d, the respective answers Q, R, S, T, U, V are allocated to the respective users A, B, C and each stored in a further Table 23, 25, 26 that is stored in the storage means of the host computer 17. In the example illustrated, the bit “1” identifies that a particular answer has been selected, and the bit “0” identifies that a particular answer has not been selected.

The allocation of the answers to a particular user A, B, C may be performed, for example, by using the MIN (Mobile Identification Number) of the respective mobile phone 2, by the phone number of the respective mobile phone 2, its SIMM number, or any other means of identification (e.g. by a password for the respective mobile phone 2, or its Internet address).

In the host computer 17, an evaluation of all incoming answers is subsequently carried out by addressing the control software stored in the storage means of the host computer 17 (with 1,000, 10,000 or 100,000 participating users A, B, C of the data communication system 1 and six predetermined answers e.g. yielding 6,000, 60,000 or 600,000 answers per advertising spot). The host computer 17 and the control software stored in its storage means are designed such that the above-mentioned evaluation is still finished during the commercial program.

For evaluation purposes, it is, for example, determined in accordance with FIG. 4b, how often a particular answer was selected for a particular question. To this end, the bits “0” or “1,” each allocated to a particular answer Q, R, S, T in Table 23, are added for all participating users A, B, C, and the respective value is stored in the Evaluation Table 24, allocating it to the respective question and to the respective answer Q, R, S, T, U, V.

In the example illustrated with 100,000 users A, B, C of the data communication system 1 participating the answer Q was given 15,000 times, the answer R 41,000 times, the answer S 28,000 times, the answer T 8,000 times, the answer U 6,000 times, and the answer V 2,000 times with respect to question 1 (and, with respect to question 2, the answer Q was given 8,000 times, the answer R 23,000 times, the answer S 31,000 times, the answer T 21,000 times, the answer U 12,000 times, and the answer V 5,000 times).

Subsequently, by addressing the control software stored in the storage means of the host computer 17, the answer that has been given most frequently is determined for each question, e.g., for question 1 answer R and for question 2 answer S, etc.

Then, it is determined which ones of the users A, B, C had selected for all questions exactly those answers that had been selected most frequently.

Among these users a random generator program selects one of the users as the “winner” (e.g., user A). Alternatively, it may, for example, also be determined that several or all of the users who had selected for all questions exactly those answers that had been selected most frequently are to be the “winners”. If none of the users selected exactly those answers that were selected most frequently, none of the users has won. In the next round, the amount of the winnings (“Jackpot”) to be distributed will be increased by the sum not distributed.

In an alternative embodiment, when the chances of winning are relatively small due to the large number of questions asked, a user may be determined to be the winner who selected exactly those answers that were selected most frequently for the largest number of questions, or, for example, a user, determined by means of variance analysis whose answers come closest to the answers selected most frequently.

In another embodiment, one of the users A, B, C (e.g. user A) is selected by means of a random generator and he/she will henceforth serve as “reference user”. The answers given by the “reference user” are, as will be described in more detail below, are used as reference answers (“leader evaluation”). The corresponding user is notified of the fact that he/she is being the “reference user”. To this end, corresponding data are transmitted from the host computer 17 via the Internet to the respective mobile phone 2 of the respective “reference user” A whose display 18 then, as seen in FIG. 2, displays a message such as “You are the leader user!”.

Subsequently, in accordance with the Table illustrated in FIG. 4a, it is determined which one of the remaining users B, C had selected exactly the same answers as “reference user” A for all questions.

Among these users B, C (alternatively by also including “reference user” A), the random generator selects one single user as the “winner”. Alternatively, it may, for example, also be determined that several or all of the users who had selected exactly the same answers as “reference user” A for all questions are to be the “winners”. In an embodiment, a user may also be determined as the winner who selected for the largest number of questions exactly the same answers as “reference user” A, or, for example, a user determined by means of variance analysis whose answers come closest to those of the “reference user” A.

Alternatively, the following variant of evaluation is used: first, it is determined for each participating user A, B, C whether and how many further participating users A, B, C have identically answered all questions 1, 2, 3, 4, 5 (or a subset of questions 1, 2, 3, 4, 5 that has been predetermined or determined by a random generator). To this end, for instance, first of all the bits for user A that are all stored in Table 23 of FIG. 4a and identify the respectively selected answers Q, R, S, T, U, V are compared with the respectively corresponding bits stored in Table 25 of FIG. 4c corresponding to the answers given by user B. If all the corresponding bits are identical, the reading of a counter, which initially has been set to zero, determining the frequency of the question-answer-combination A selected by user A is increased by one. Otherwise, the reading of the counter remains unchanged.

Subsequently, in a corresponding manner, the answers Q, R, S, T, U, V given by user A are successively compared with the answers given by user C and the remaining users by comparing corresponding bits stored, for example, in Tables 23 or 26. After each comparison, the reading of the counter is, depending on whether identity of all bits exists or not, either increased by one or left unchanged.

In correspondence, the question-answer-combination B of the second user B is compared with that of the remaining users. Corresponding comparisons are also performed for the question-answer-combination of the third user C and for the question-answer-combinations of the remaining users. This way, the respectively occurring frequency may be determined for each question-answer-combination A, B, C, etc., for example, by means of taking the readings of the various counters. This frequency is, allocated to the corresponding question-answer-combination A, B, C, stored in a further Evaluation Table 27. In a further column of Table 27 is stored which users have exactly selected a particular question-answer-combination.

As “group of winners” those users A, X, Y, etc., may, for instance, be determined who selected the question-answer-combination A that has been selected most frequently. Alternatively, a “group of winners” may also include those users C, etc., who selected the question-answer-combination with the least frequency (or the least, but larger than 0), or any other “group of winners” that is determined, for instance, by a random generator with users B, Z, etc., where the frequency is larger than 0 (i.e. the question-answer-combinations of at least two users concur). Alternatively, several such “groups of winners” may also be determined.

Among the users belonging to the one or the several “group(s) of winners”, one single user or a number of users may be selected as the final “winner(s)” by means of a random generator. Alternatively, all members of the one or several “group(s) of winners” may be final “winners”.

In another embodiment, instead of taking into account only one single advertising spot which questions 1, 2, 3, 4, 5 relate to, several advertising spots broadcasted during a commercial program are taken into account for the abovementioned methods of determining winners. The winner then is determined to be, for example, the user who has selected for all or an optional part of, for instance, seven advertising spots times five questions=35 questions, exactly those answers that were all in all selected most frequently.

Alternatively, only one single question may be asked for each advertising spot instead of several questions. In this example, it is preferred if one and the same question (e.g. the above-mentioned question 1, with, for example, question 2, or more than 2, e.g. 5 or 6, possible answers Q, R, S, T, U, V) is asked for all advertising spots of a commercial program (e.g. for more than 2, e.g. for 3, 4 or 5 advertising spots).

The amount of the respectively distributed winnings is stored in the storage means of the host computer 17. A fixed amount that has been determined in advance may, for instance, be distributed. This may be a fixed share, e.g. 10% of the amount that the respective television or radio corporation obtains from the advertiser(s) for the broadcasting of a particular advertising spot or for the entire commercial program consisting of a plurality of spots.

Alternatively, the amount of the respectively distributed winnings may be determined individually each time prior to performing the determination of a winner, for example, as a function of the amount of the instantly participating users. The amount of the entire winnings distributed may, for instance, be directly proportional to the number of users or it may be indirectly proportional to the number of users. Beforehand, the number of the instantly participating users is determined by addressing the control software.

All participating users and all or part of the potential users are informed of the number of participating users A, B, C and/or the amount of the respective winnings to be distributed. The corresponding data are transmitted to the respective mobile phones 2, 3, 4 from the host computer 17 via the Internet, the above-mentioned host computers and the mobile radiotelephone network base stations 15, 16. These data then cause the display 18 of the respective mobile phone 2 displays corresponding messages such as “100,000 participants” and/or “$10,000 winning sum”. Immediately after the determination of the respective winners they are informed of the fact that they were selected as winners. To this end, corresponding winning information data are transmitted from the host computer 17 to the mobile phones 2, 3, 4 allocated to the respective winners. These data then cause that the display 18 of the respective mobile phone 2 displays a winning message, for example, the message “Winnings!”. It is preferred that the respective user A is simultaneously informed of the amount of the respective winnings gained (e.g. by means of the message “You win $10,000”). A corresponding message is also transmitted to the other participating users in the form of the message “A player has just won $10,000 !”

A real time market research (real time polling or paneling) may be performed. The recollection of a product name may, for instance, be tested by sending, in the abovementioned way, corresponding questions to the mobile phones 2 of the respective users A after a certain time from the broadcasting of a commercial program has lapsed. The answering of such questions may, in analogy to the above explanation, again be awarded by distributing corresponding winnings.

Moreover, existing incentives to buy may directly be turned into buying activity by the system 1. One can, for instance, directly after the end of the respective advertising spot/the respective commercial program, make an automatic link to the corresponding Website of a product supplier when the question “Are you interested in buying this product?” has been answered with “Yes”, or further product information may be transmitted to the mobile phone 2 of the corresponding user A via the Internet, etc.

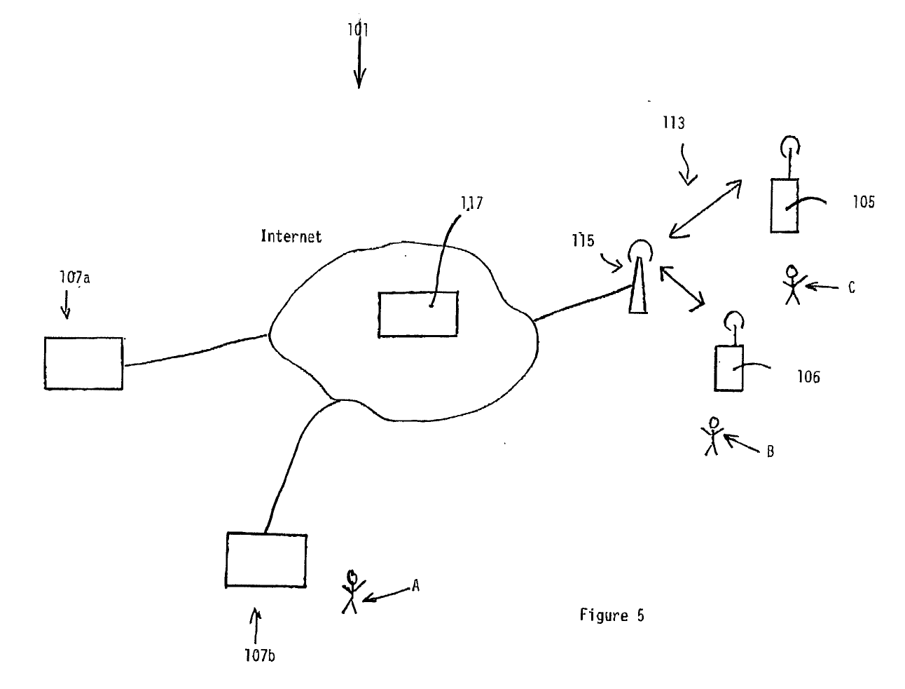

FIG. 5 illustrates a further embodiment of the data communication system 101 of the present invention. As input/output devices, a plurality of stationary or mobile computers 107a, 107b that are linked or may be linked with the Internet, e.g., conventional PCs (Personal Computers), PDAs (Personal Digital Assistants), and so forth, are used in addition to mobile phones 105, 106 having WAP or UMTS capability. The mobile phones 105, 106 and the computers 107a, 107b simultaneously also assume a function that corresponds to the function fulfilled in the embodiment according to FIG. 1 by the television sets or radio receivers 5, 6, 7, 10, 11.

As shown in FIG. 5, the mobile phones 105, 106 are linked with corresponding mobile radiotelephone networks 113 via base stations 115 and perform bi-directional data communication with the respective mobile radiotelephone network base stations 115, e.g., by making use of the WAP, GPRS or UMTS protocol. From the respective base station 105, the data are transmitted to the Internet and, from there, to an Internet host computer 117.

The Internet host computer 117 transmits the WAP or Internet sites requested by a certain mobile phone 105, 106 (or the image data (or image/sound data) requested by it) via the Internet, the above-mentioned host computers and the mobile radiotelephone network base stations 115 to the respective requesting mobile phone 105, 106.

In a corresponding way, data stored on the storage means of the host computer 117, e.g., Internet sites, are accessible from the computers 107a, 107b. To this end, e.g., the URL address pertaining to the respective Internet site is input into the corresponding computer 107a, 107b. The respectively requested Internet site (or the requested image or image/sound data, respectively) then are transferred to the respectively requesting computer 107a, 107b via the Internet.

On a screen 118a of the respective computer 107a, 107b or on a display 118b of the respective mobile phone 105, 106, the images corresponding to the image data then are displayed. Optionally, the sound signals corresponding to the sound data received are additionally emitted by loudspeakers provided at the computers or mobile phones, respectively.

The images transmitted from the host computer 117 promote certain goods and/or services. This may be effected, for example, in the form of stationary individual images, or in the form of moving images, e.g., advertising spots.

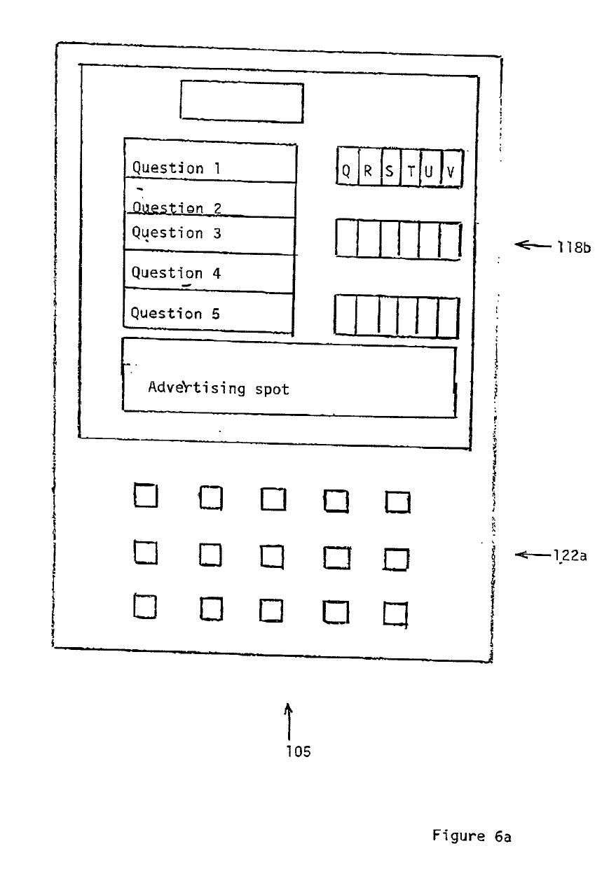

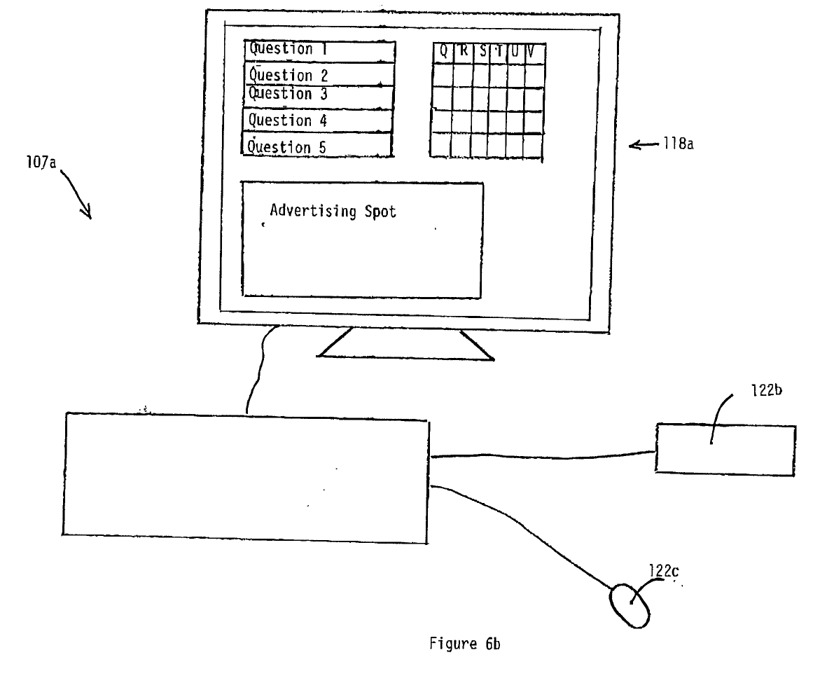

Referring to FIGS. 6a and 6b, each mobile phone 105 and each computer 107a includes, in addition to the display 118b or the screen 118a, an input means, i.e., a keyboard 122a, 122b or a mouse 122c, respectively. The display 118b of the mobile phone 105 or the screen 118a of the computer 107a displays questions directed to the respective user A, B, C with regard to the respective advertising spot, i.e., questions 1, 2, 3, 4, 5, for example, in the form of text messages, in addition to the respective advertising spot.

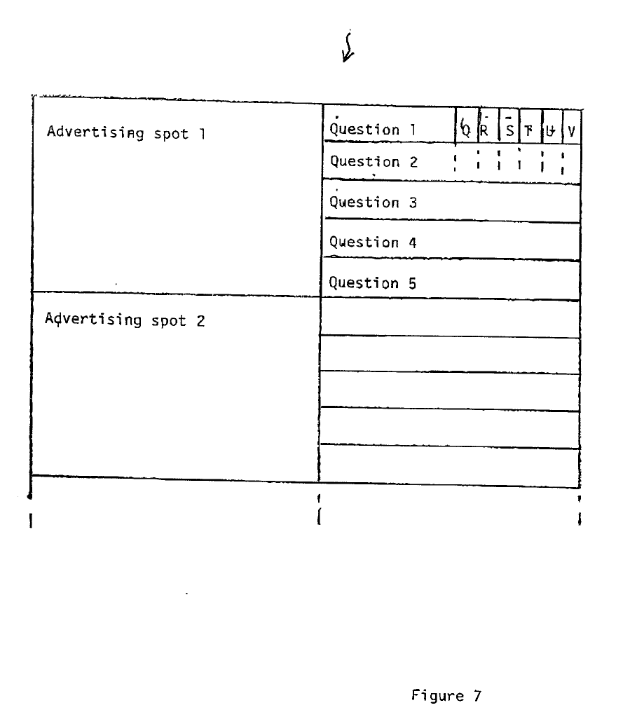

Referring now to FIG. 7 a data cross-reference table 119 is stored in a database that is stored in a storage means (not shown) of the Internet host computer 117. In the cross-reference table 119, the text messages, e.g., the abovementioned questions 1, 2, 3, 4, 5, transmitted from the Internet host computer 117 to the respective mobile phone 105 or the respective computer 107a, respectively, each are allocated to a particular advertising spot. Instead of using a cross-reference table, the allocation of data may also be achieved in any other way, e.g., using a correspondingly installed relational database stored in the storage means.

The questions relating to the advertising spots are, for instance, asked such that they have to be answered with “Yes” or “No.” Examples include “Do you like this advertising spot?” “Do you like this product?” “Are you interested in buying this product?”), or, for instance, with one out of several, e.g. four, five or six, predetermined possible answers. Examples include “How do you like this advertising spot?” “How do you like the leading actress?” “How do you like this product?”, the possible answers being Q, R, S, T, U, V “excellent”, “very good”, “good”, “average”, “bad”, “very bad”).

The predetermined answers Q, R, S, T, U, V that are allocated to the corresponding question are also stored in the storage means of the host computer 117 and are transferred, together with the questions, to the respective mobile phone 105 or the respective computer 107a, respectively, are intermediately stored there and displayed on the respective display 118b or on the respective screen 118a, respectively, such as in accordance with FIGS. 6a or 6b.

The respective user A, B, C of the mobile phone 105 or the computer 107a, respectively, may select one of the predetermined answers by performing a corresponding input with the keyboard 122a, 122b, or the mouse 122c, for instance by clicking (alternatively, the selection may be carried out in any other way, e.g. in the case of a touch screen display by touching corresponding spots of the display 118b).

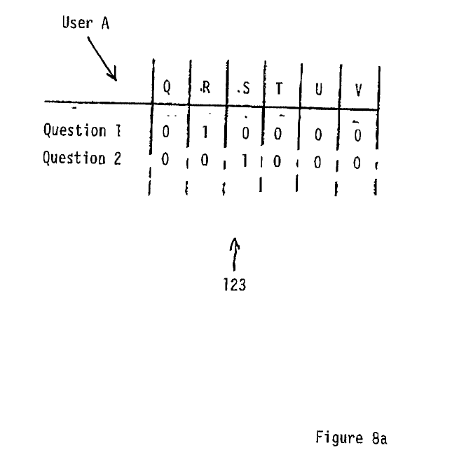

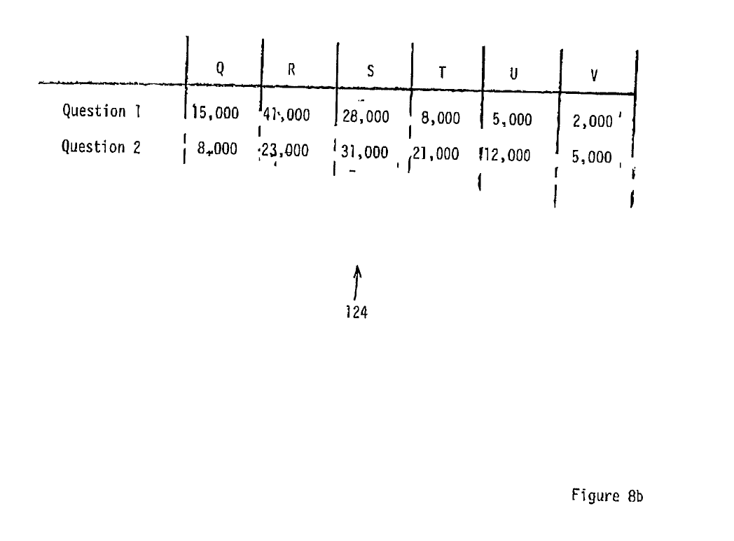

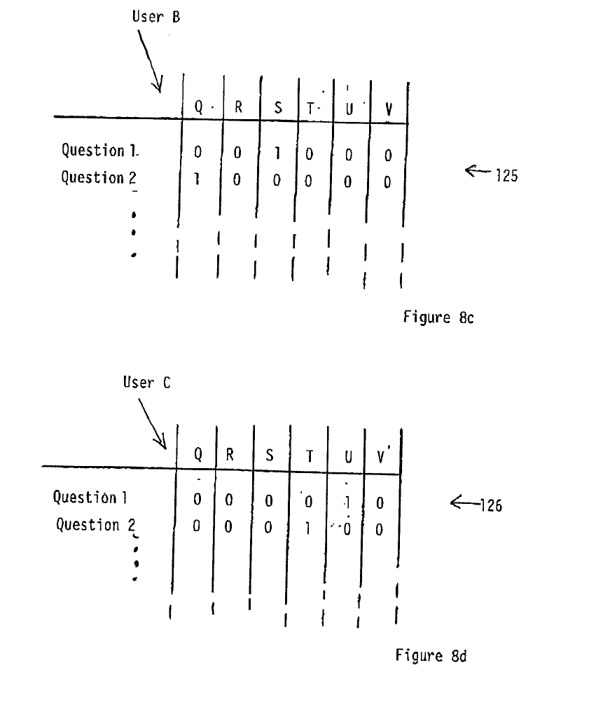

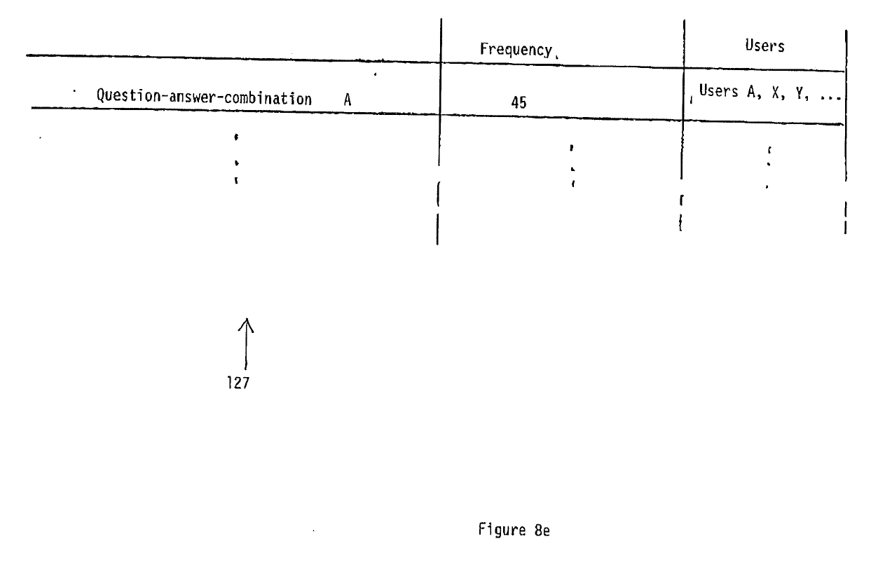

Referring back to FIG. 5, the answers (e.g., in the form of different bit sequences allocated to each answer) are transmitted from the respective mobile phone 105 or the respective computer 107a via the Internet to the host computer 117 where, in accordance with FIG. 8a, the respective answers are allocated to the respective users A, B, C and each stored in a further Table 123 that is stored in the storage means of the host computer 117. In the example illustrated, the bit “1” identifies that a particular answer has been selected, and the bit “0” identifies that a particular answer has not been selected. Corresponding Tables 125, 126 exist, in accordance with FIGS. 8c, 8d, also for the remaining users B, C, etc.

The allocation of the answers to a particular user A, B, C may be performed, for example, by using the Internet address of the respective computer 107a, or by using the MIN (Mobile Identification Number) of the respective mobile phone 105, by its phone number or SIMM number, or for example, by a password for the respective mobile phone 105, or its Internet address.

In the host computer 117, an evaluation of all incoming answers is subsequently carried out by addressing the control software stored in the storage means of the host computer 117 (with 1,000, 10,000 or 100,000 participating users A, B, C of the data communication system 101 and six predetermined answers yielding 6,000, 60,000 or 600,000 answers per advertising spot). The host computer 117 and the control software are designed or programmed such that the above-described evaluation is still finished during or shortly after the broadcasting of the respective advertising spot.

For evaluation purposes it is, for instance, how often a particular answer was selected for a particular question. To this end, the bits “0” or “1”—each allocated to a particular answer Q, R, S, T in Table 123 are added for all participating users A, B, C, and the respective value is stored in the evaluation Table 124, allocating it to the respective question and to the respective answer Q, R, S, T, U, V.

In the example illustrated with 100,000 users A, B, C of the data communication system 101 participating the answer Q was given 15,000 times, the answer R 41,000 times, the answer S 28,000 times, the answer T 8,000 times, the answer U 6,000 times, and the answer V 2,000 times with respect to question 1 (and, with respect to question 2, the answer Q was given 8,000 times, the answer R 23,000 times, the answer S 31,000 times, the answer T 21,000 times, the answer U 12,000 times, and the answer V 5,000 times). Subsequently, by addressing the control software of the host computer 117, the answer that has been given most frequently is determined for each question (here: for question 1 answer R and for question 2 answer S, etc.). Then, it is determined which ones of the users A, B, C had selected for all questions exactly those answers that had all in all been selected most frequently. Among these users a random generator stored on the host computer 117 selects one of the users as the “winner” (here: user A).

The variants with respect to the determination of a winner as described above in connection with FIG. 1, and the possibilities of determining the amount of winnings may correspondingly also be applied with the embodiment illustrated in FIG. 5.

Alternatively, as described above, the following variant of evaluation is used. First of all, it is determined for each participating user A, B, C whether and how many further participating users A, B, C have identically answered all questions 1, 2, 3, 4, 5 (or a subset of questions 1, 2, 3, 4, 5 that has been predetermined or determined by a random generator). To this end, for example, first of all the bits for user A that are all stored in Table 123 of FIG. 8a and identify the respectively selected answers Q, R, S, T, U, V are compared with the respectively corresponding bits stored in Table 125 of FIG. 8c corresponding to the answers given by user B. If all the corresponding bits are identical, the reading of a counter (which initially has been set to zero) determining the frequency of the question-answer-combination A selected by user A is increased by one. Otherwise, the reading of the counter remains unchanged. Subsequently, in a corresponding manner, the answers Q, R, S, T, U, V given by user A are successively compared with the answers given by user C and the remaining users (by comparing corresponding bits stored in Tables 123 or 126, respectively). After each comparison, the reading of the counter is, depending on whether identity of all bits exists or not, either increased by one or left unchanged.

In correspondence, the question-answer-combination B of the second user B is compared with that of the remaining users. Corresponding comparisons are also performed for the question-answer-combination of the third user C and for the question-answer-combinations of the remaining users. This way, the respectively occurring frequency may be determined for each question-answer-combination A, B, C, etc., for instance, by means of taking the readings of the various counters. The frequency is, allocated to the corresponding question-answer-combination A, B, C, stored in a further Evaluation Table 127 in accordance with FIG. 8e. In a further column of Table 127 is stored which users have exactly selected a particular question-answer-combination.

As “group of winners” those users A, X, Y, . . . , may, for instance, be determined who selected the question-answer-combination A that has been selected most frequently. Alternatively, a “group of winners” may also comprise those users C, . . . , who selected the question-answer-combination with the least frequency (or the least, but larger than 0), or any other “group of winners” that is determined, for instance, by a random generator with users B, Z, . . . , where the frequency is larger than 0 (i.e. the question-answer-combinations of at least two users concur). Alternatively, several such “groups of winners” may also be determined.

Among the users belonging to the one or the several “group(s) of winners”, one single user or a plurality of users may be selected as the final “winner(s)” by means of a random generator. Alternatively, all members of the one or several “group(s) of winners” may be final “winners”.

Moreover, instead of the questions 1, 2, 3, 4, 5 relating to one single advertising spot, corresponding questions relating to several, e.g., seven successive advertising spots, may be taken into account. The winner then is determined to be the user who has selected for all (or an optional part) of, for instance, seven advertising spots times five questions equals 35 questions, exactly those answers that were all in all selected most frequently. In order to exclude possibilities of manipulation, the seven advertising spots used may be transmitted such that they are issued on the various mobile phones or computers, respectively, in different, permutated, sequence each. This restricts the possibilities for the different users A, B, C to make arrangements.

Alternatively, only one single question may be asked for each advertising spot (instead of several, e.g., more than 1, 2, 3 or 5 questions). In this case, it is of particular advantage if one and the same question (e.g., the above-mentioned question 1, with, e.g., 2 or more than 2, e.g., 5 or 6, possible answers Q, R, S, T, U, V) is asked for all advertising spots of a commercial program (e.g., for more than 2, e.g. for 3, 4 or 5 advertising spots).

All participating users and all or part of the potential users are informed of the number of participating users A, B, C and/or the amount of the respective winnings to be distributed. The corresponding data are transmitted from the host computer 117 via the Internet to the respective mobile phones 105 or the respective computers 107a. These data then cause that the respective display 118a, 118b displays corresponding messages such as “100,000 participants!” and/or “$10,000 winning sum”.

Immediately after the determination of the respective winners they are informed of the fact that they were selected as winners. To this end, corresponding winning information data are transmitted from the host computer 117 to the mobile phone 105 or the computer 107a, respectively, allocated to the respective winner.

These data then cause that the respective display 118a, 118b displays a winning message, e.g., the message “Winnings!”. The respective user A is simultaneously also informed of the amount of the respective winnings gained (e.g., the message “You win $10,000”).

A corresponding message is also transmitted to the other participating (and/or all or part of the potential) users, e.g. in the message “A player has just won $10,000 !”

By means of the data stored in the storage means of the host computer 117, real time market research (real time polling or paneling) may be performed. The recollection of a product name may, for instance, be tested by sending, in the abovementioned way, corresponding questions to the mobile phones 105 or the computers 107a of the respective users A, B, C after a certain time from the broadcasting of a commercial program has lapsed. The answering of such questions may, in analogy to the above explanation, again be awarded by distributing corresponding winnings.

Moreover, incentives to buy may directly be turned into buying activity by the system 101 according to the invention. One can, for instance, make a link to the corresponding Website of a product supplier if questions concerning the advertising spot of a particular product have been answered in a certain way, and so forth.

Further aspects, features and advantages will become apparent from the following claims.

What is claimed is:

1. A data communication system comprising:
a plurality of output devices;
a plurality of input devices allocated to a plurality of users of the system; and
at least one host computer, wherein identical information is output at the output devices, and the host computer transmits to the output devices further information allocated to the identical information, data relating to the further information and input into the plurality of input devices are transmitted to the host computer, and wherein the host computer selects, in response to the data received from the plurality of input devices, one or a subset of users and transmits a selected message to the selected user or subset of users.

2. The system of claim 1, wherein the identical information is advertising information allocated to a particular product or service.

3. The system of claim 1, wherein the further information allocated to the identical information is questions directed to the user or subset of users of the respective input devices.

4. The system of claim 2, wherein the further information allocated to the identical information is one or more questions directed to the user or subset of users of the respective input device.

5. The system of claim 4, wherein the host computer selects a user whose answers to the questions correspond to a set of reference answers stored in the host computer.

6. The system of claim 5, wherein the set of reference answers is determined from answers given by the plurality of users.

7. The system of claim 6, wherein the set of reference answers is determined on the basis of a frequency of individual answers given by the plurality of users.

8. The system of claim 6, wherein answers contained in the set of reference answers correspond to answers selected by a particular one of the plurality of users.

9. The system of claim 1, further comprising:
at least 1,000 input devices; and
at least 1,000 output devices.

10. The system of claim 1, wherein the identical information is transmitted from a master station.

11. The system of claim 1, wherein the plurality of input devices are mobile phones.

12. The system of claim 1, wherein the plurality of output devices are mobile phones.

13. The system of claim 11, wherein the plurality of output devices are television sets.

14. A data communication method, the method comprising:
outputting identical information to a plurality of output devices;
transmitting from a host computer further information associated with the identical information to the plurality of output devices; and
providing a plurality of input devices allocated to a plurality of different users such that data relating to the further information and input into the respective input devices are transmitted to the host computer, and the host computer selects, in reaction to the data received from the input devices, one or a subset of the plurality of users and transmits a selected message to the one user or subset of selected users.
